(19) United States
(12) Patent Application Publication
(10) Pub. No.: US 2006/0181462 A1
(43) Pub. Date: Aug. 17, 2006

(54) Integrated antenna/access door for a mobile computer

(75) Inventors: Stephen J. Kelly, Marion, IA (US); Christopher Cleland, Cedar Rapids, IA (US); Thomas J. Schuster, Cedar Rapids, IA (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Intermec IP Corp., Everett, WA (US)

(21) Appl. No.: 11/057,457

(22) Filed: Feb. 14, 2005

(51) Int. Cl. H01Q 1/24

(52) U.S. Cl. 343/702

(57) ABSTRACT

A mobile computer having an access door with an integrated antenna system. The access door comprises an antenna board mounted inside a radome. The antenna board contains one or more antennas, and is located inside the radome access door at a position which allows the antenna or antennas to send and receive data with minimal interference from the computer screen or computer housing.

### CROSS-REFERENCE TO RELATED APPLICATION(S)

None.

### BACKGROUND OF THE INVENTION

The present invention relates to antennas for use with mobile computers, and more specifically relates to an antenna integrated into an access door of a mobile computer.

Use of computers is no longer limited to desktop or office applications. Instead, computers are increasingly used in a wide variety of applications and locations, including mobile computers installed in various types of vehicles. Specifically, material handling vehicles, such as fork lifts, maybe equipped with mobile computers to assist workers in various material handling matters in warehouses or other industrial settings. One such computer is the CV60 Vehicle Mount Terminal made by Intermec Technologies Corporation of Everett, Wash.

It is preferable for mobile computers to be highly configurable during manufacturing to allow for customizing the computer based on the diverse needs and demands of users. To allow for such customization, many mobile computers have a modular design and are configured with expansion slots. The expansion slots provide a location for equipping the computer with a variety of electronics, such as additional memory or wireless communications capability. A modular design may also make it more convenient to swap-out hard drives and other mass storage devices. To allow access to these expansion slots, mobile computers are typically configured with access doors. The access doors provide access to the optional expansion slots so that the computer can be customized during manufacturing or upgraded or serviced later by the user.

Mobile computers used in more rugged applications typically require sturdy housings, and maybe formed of a metal such as cast magnesium, or other suitable material. Similarly, for ease of use by an operator, the user interface of the computer maybe configured as a touch panel rather than keyboard. In such instances, the touch panel maybe formed of eighth-inch tempered glass screwed to the computer housing, so as to be easily replaceable should this glass be damaged or broken due to the harsh environment. Similarly, the magnesium housing must be sufficiently sealed, particularly at the access door, so that the computer can withstand the dust, dirt, moisture, or extreme temperatures of the environments in which the computer is used.

In addition to a touch panel, the computer may receive and transmit data through wired or wireless connections. For wireless applications, an antenna must be used to allow the computer to send and receive data. Indeed, the mobility required by computers used in many applications leads to a high demand for mobile data solutions and wireless networks.

In the past, mobile computers were often configured with several antennas to allow for such wireless data transmissions from one or several RF co-located devices. Often, each computer would have several wire “whip” antennas, or a so-called “antenna farm,” located external to of the computer housing. However, given the rugged environment in which the computer was used, these external whip antennas were highly susceptible to being broken or damaged, such as when an item was dropped on the computer or when the antenna was snagged by something. In some instances, operators were issued new antennas in the morning, to ensure the antennas were in working order, and were required to turn in the antennas at the end of the shift.

In response to the problems of antennas being broken or damaged, a plastic enclosure was added to the computer housing to enclose the antennas. However, adding external plastic enclosures to cover the external antennas added cost and complexity to the manufacturing process, while at the same time affecting the performance of the antenna. This also had the effect of increasing the case dimensions significantly. Another attempt at solving this problem was to integrate the antennas inside the computer housing. However, when the computer housing is formed of a metal, placing the antenna inside this metal “box” compromised the performance of the antennas. In addition, locating the antennas near the internal electronics of the computer may impede proper function of either the antenna or the electronics or both. As such, incorporating antennas into the computer housing may not an optimal solution.

Thus, there is a need in the art for antennas that are highly robust in extreme environments yet obtain the necessary performance. In addition, there is a need in the art for flexibility and ease in manufacturing and upgrading/maintaining such systems. Additionally, as more radio systems are invented, there is a need to handle a plurality of antennae on one unit with one (or multiple) access doors.

### BRIEF SUMMARY OF THE INVENTION

The present invention relates to a mobile computer having an antenna integrated into the computer's access door(s). The improved access door comprises a radome and a plurality of integrated antennas located in the radome. Integrating the antennas into the access door protects the antennas from being damaged or broken, while still allowing the antennas to be placed on the computer in a location that ensures functionality. To ensure the integrated access door and antenna do not diminish the functionality of the computer, a gasket maybe included to ensure proper sealing between the access door and the computer housing.

### BRIEF DESCRIPTION OF THE DRAWINGS

FIG. 1 is a perspective view of a type of mobile computer.

FIG. 2 is a perspective view of a mobile computer having an antenna integrated into the access door.

FIG. 3 is a side perspective view of the access door of the present invention opened to reveal the inside of the computer.

FIG. 4 is a perspective view of the radome in an open position.

FIG. 5 is a top perspective view of a portion of the computer and the integrated antennas.

FIG. 6 is a cross sectional view of a radome access door having an integrated antenna system.

FIG. 7 is a perspective view of handheld computers configured with the present invention.

### DETAILED DESCRIPTION

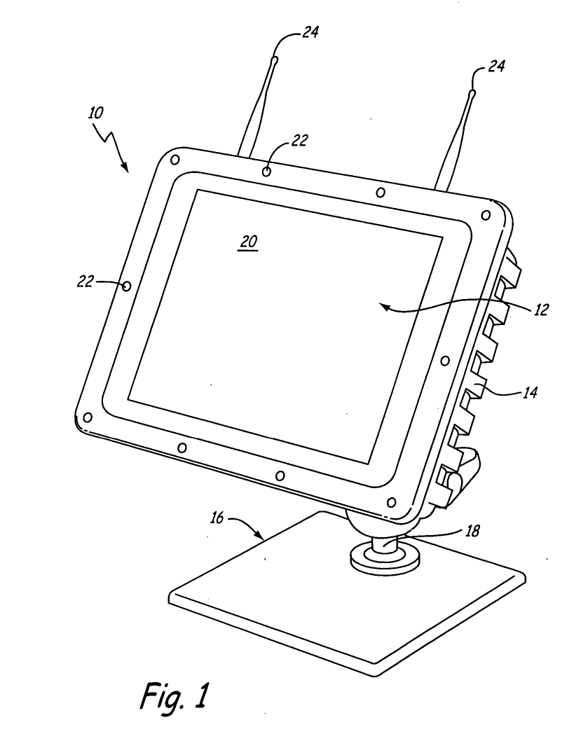

FIG. 1 is a perspective view of a mobile computer 10. The computer 10 comprises a computer screen 12, computer housing 14, and computer base 16. The computer 10 connects to the computer base 16 at hinge 18. The hinge 18 maybe any sort of suitable connection hinge, allowing the computer 10 to be tilted or rotated. Further, the base 16 maybe any sort of suitable base for allowing the computer to be either vehicle or stationary mounted.

The computer 10 is configured for real time data collection in a variety of rugged applications, such as in manufacturing, warehousing, distribution, and transportation environments. As such, both the screen 12 and housing 14 are designed to ensure the computer is capable of withstanding a wide range of environmental conditions. For instance, the computer screen 12 maybe a touch screen so that the user may interface with the computer 10 without needing a keyboard. The touch screen display 12 may comprise a glass screen 20 connected to the housing 14 by a series of screws 22. In this way, should the screen 12 become damaged or broken, it can easily be replaced.

The housing 14 houses the electronics necessary for the computer 10 to operate. To further ensure that the computer 10 can function in rugged situations, the housing 14 may be formed of a suitable, high-performance material. One such suitable material is cast magnesium.

In many applications, the computer 10 is used with either wired or wireless accessories. Wireless accessories are preferred because the user has fewer accessories to install, cables to contend with, or tethered wires to affect mobility. To accommodate wireless accessories, the computer 10 must be equipped with several antennas 24. The “whip” type antennas 24 are typically placed along the top of the computer 10 to ensure the best performance of the antennas 24. However, such antennas 24 are prone to becoming broken or damaged.

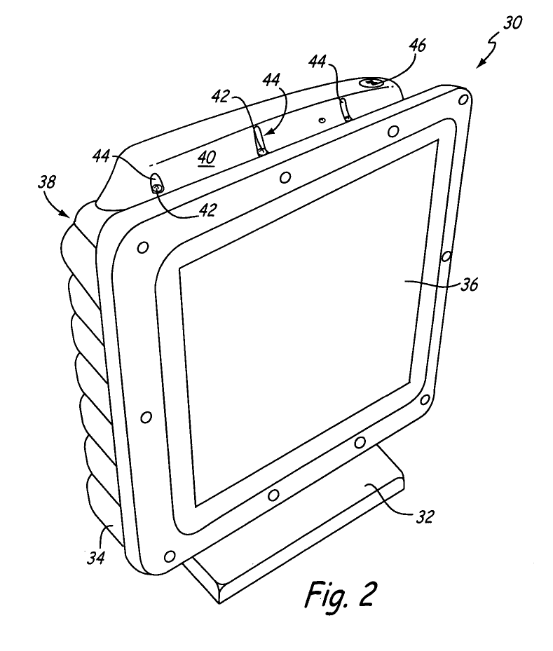

FIG. 2 is a top perspective view of a mobile computer 30 illustrating the present invention. The mobile computer 30 is attached to a base 32. Similar to the computer 10 of FIG. 1, the computer 30 comprises a metal housing 34 and a touch screen 36. Located on atop surface 38 of the computer 30 is a plastic radome 40. The radome 40 is affixed to the metal housing 34 by a plurality of screws 42. The radome 40 may be shaped, such as with draft angles 44, to provide a convenient location for inserting screws 42 to connect the radome 40 to the housing 34. Also located on the radome 40 is a remote or external antenna port 46. The external antenna port 46 allows a user to connect a remote antenna (not shown) to the computer 30 by plugging the remote antenna into the port 46 on the computer 30.

The radome 40 is an enclosure for protecting an antenna from the effects of the physical environment, while minimally affecting the antenna's performance. The radome 40 is formed of any suitable material, such as a high-impact plastic. Further, the radome 40 is preferably located at the top of the computer 30, and is shaped to extend above the computer screen 36. The radome 40 functions not only as a housing for an antenna or plurality of antennas, but also is part of an access door allowing access into the housing 34 of the computer 30.

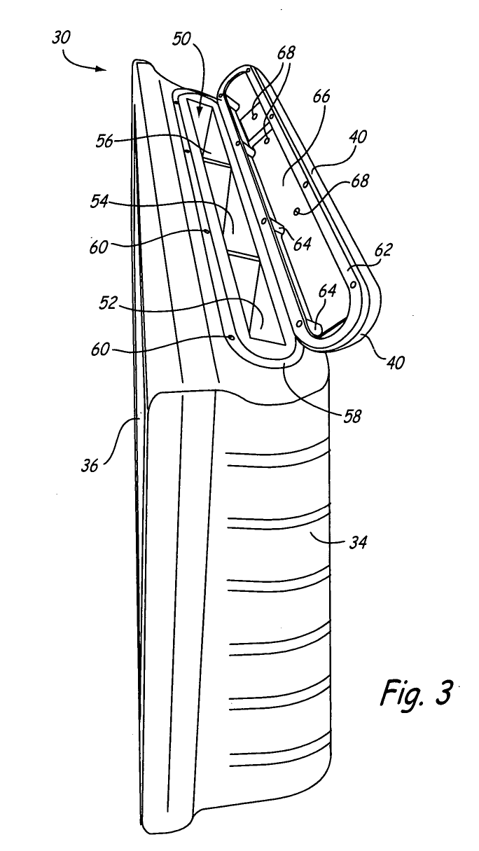

FIG. 3 is a side perspective view of the computer 30 showing the radome/access door 40 flipped open. As described above, the radome 40 acts as an access door to the interior 50 of the computer housing 34. The interior 50 of the housing 34 often has a modular construction allowing for expansion of various computer components. As shown in FIG. 3, the computer has three expansion slots 52,54, and 56. The expansion slots 52, 54, and 56 may have a variety of uses, such as for expanding memory or customizing the computer for various wireless applications. Also visible is a groove 58 extending around the top of the computer 30. Located in the groove 58 are several screw receiving holes 60.

The radome/access door 40 comprises a seal 62 and several cylindrical screw channels 64 through which screws can be inserted. The seal 62 corresponds in size to the groove 58 on the computer housing 34. In this way, the radome 40 can be affixed to the housing 34 by inserting screws through the screw channel 64 and screwing them into the screw holes 60 in the groove 58. The groove 58 and the corresponding seal 62 allow the radome 40 to be snugly affixed to the housing 34. The seal 62 serves to ensure that once the radome 40 is affixed to the housing 34, the computer 30 is properly sealed so that no moisture, dirt, and dust enters the interior 50 of the computer 30.

An antenna board 66 is located in the radome/access door 40. The antenna board 66 is affixed to the radome/access door 40 in any suitable manner, such as by a plurality of screws 68. The antenna board 66 provides a location for one or more antennas to be located in the radome 40. The antenna board 66 is preferably positioned inside the radome/access door 40 such that any antennas located on the board 66 will be positioned above the screen 36 and outside the metal housing 34 once the radome/access door 40 is affixed to the housing 34.

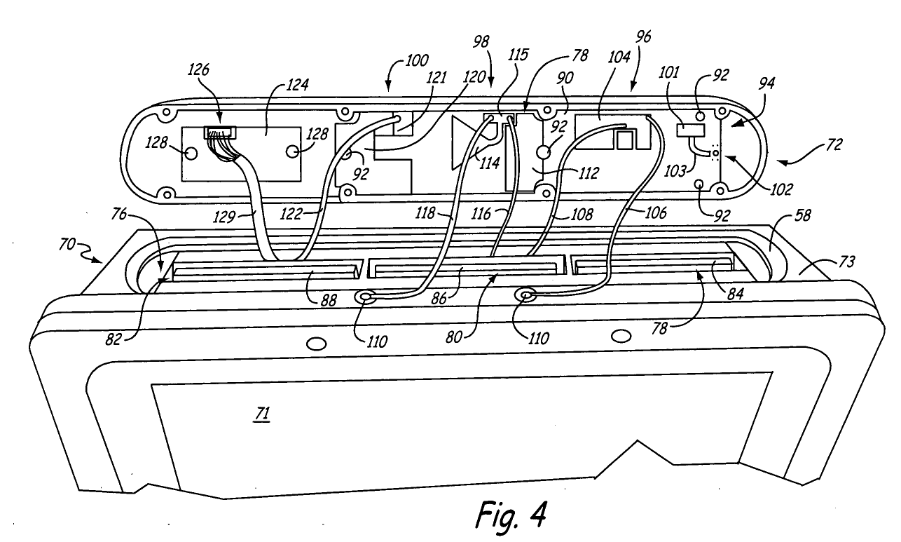

FIG. 4 is a front perspective view of a mobile computer 70 illustrating one embodiment of an access door 72 having an integrated antenna system 74. Shown in FIG. 4 is a portion of the computer 70, the access door 72, the integrated antenna system 74 located in the access door 72, and the interior 76 of the computer 70. The computer 70 also comprises a touch screen 71 as a user interface, as well as a metal housing 73, to ensure the computer 70 is suitable for use in a variety of rugged applications. In addition to containing the electronic components of the computer 70, the interior 76 of the computer comprises three expansion slots 78, 80, 82 to allow for customization of the computer 70.

One advantage of the present system is that the computer 70 is highly configurable. Placing the antenna system 74 in the access door 72, and designing the computer with expansion slots 78-82 near the access door 72 allows the computer 70 to be easily customized at the time of manufacturing. The computer 70 can be manufactured in a standard manner up to the point where consumer-decided options are to be added. As such, the options can be added very late in the assembly of the computer, reducing the cost and difficulty involved in manufacturing, and at the same time improving the speed at which a computer having the customer desired options can be delivered.

Similarly, service is improved as well as basic access. Thus, even after manufacturing, a user can easily open the computer and replace, repair, or add any components as needed. Previous mobile computers were not as configurable, and often required the user to completely disassemble the computer to gain access to the motherboard or install additional radios or electronic components.

The expansion slots 78, 80, and 82 maybe configured for accepting any variety of electronics. Specifically, the first expansion slot 78 may be configured to conform to the Personal Computer Memory Card International Association (PCMCIA) standard. A PCMCIA expansion slot 78 is often used for such things as memory expansion or similar products configured to fit into a PCMCIA slot. In FIG. 4, a memory expansion card 84 is shown diagrammatically in the first expansion slot 78. Memory expansion card 84 does not need an antenna, though other components used in connection with the PCMCIA slot 78 may.

The second expansion slot 80 may be configured as a PCI (peripheral component interconnect) or a mini PCI slot. A PCI or mini PCI slot allows a user to plug peripheral devices into the motherboard. One typical type of device plugged into a mini PCI slot is a mini PCI radio 86. Shown diagrammatically in the second expansion slot 80 is one type of mini PCI radio 86, an 802.11 type radio. The third expansion slot 82 maybe configured to accept any variety of radio module. One example of a radio module for use in the mobile computer 70 is a pico-link radio system 88, shown diagrammatically in FIG.4. The pico-link radio system 88 maybe any suitable type of radio configured for use in a pico-link wireless network.

The mobile computer 70 may likewise be configured with yet another type of wireless technology, such as a Bluetooth™ radio. The Bluetooth™ radio is typically not located in an expansion slot 78-82, but rather maybe located inside the computer 70 in any suitable manner.

Placing the expansion slots 78, 80, and 82 near the top of the housing 73 ensures any components placed in the expansion slots 78-82 are located proximate the access door 72 and the antenna system 74 located therein. The antenna system 74 is provided to allow for wireless operation of the electrical components located in the expansion slots or in the computer 70. Specifically, the antenna system 74 comprises antennas for use with the the 802.11 radio 86, pico-link radio 88, and Bluetooth™ radio. The antenna system 74 comprises an antenna board 90, which is connected to the access door 72 in any suitable manner, such as by four screws 92.

Located on the antenna board 90 is a remote antenna connection 94 and three antennas 96, 98, 100. The remote antenna connection 94 corresponds to the location for connecting the computer 70 to the external port 46 (FIG. 2). A remote antenna refers to any antenna located off the computer 70.

A remote antenna maybe used when the computer is in a location which requires better radio performance or when the computer is located in a place on the Vehicle that is more sheltered to protect the computer. For instance, if the computer is located in the cab of a truck, and the computer is not achieving the range necessary for the radio to operate, the remote antenna connection 94 can be utilized to allow a remote antenna to be connected to the computer 70. Such antennas have high gain that is not available on an integrated antenna, and allow the customer to place them at a distance from the broadcasting unit. Use of a remote antenna is be a customer selectable option.

The remote antenna connection 94 comprises a bond pad 101 and mounting hardware 102. The bond pad 101 is electrically connected to the mounting hardware 102 by a lead 103. To utilize the external port, a wire from the computer must be connected to the bond pad 101, which in turn is electrically connected to the external port by lead 103 at mounting hardware 102. As shown in FIG. 4, this option is not in use. However, should a user later determine that a remote antenna is necessary, such a configuration is easily added.

The first antenna 96 comprises a grounding area 104, a ground wire 106, and a first antenna wire 108. The grounding area 104 comprises a layer of suitable material, such as a metal, located on the antenna board 90, which provides the ground plane against which the first antenna 96 operates. Though indicated generally as a rectangle, the grounding area 104 is not so limited in shape or size. In particular, the first antenna 96 maybe tuned for any number of variations, including the type of radio for which the first antenna 96is used. The first antenna 96 may further be tuned based on the desired performance of the first antenna 96 and how this performance is affected by the particular size or design of the radome cavity or the type plastic used for the access door 72. The grounding area 104 will vary based on the antenna tuning or desired performance. As such, the size, shape, and location of the grounding area 104 on the antenna board 90 may vary.

The first antenna 96 is connected to the computer 70 using the ground wire 106 and the antenna wire 108. The ground wire 106 connects the first antenna 96 to ground, such as by connecting the antenna 96 to the housing 73 of the computer 70 as shown. The ground wire 106 grounds the antenna board 90 and also serves to prevent electrostatic discharge (ESD) events or static electricity buildup on the surface of the antenna board 90. Should static electricity build-up or ESD result, such arcing may be harmful to the computer, the antenna system 74, or other aspects of the computer's operation.

The antenna wire 108 provides a connection between the first antenna 96 and the mini-PCI radio 86 located in the second expansion slot 80. As such, the antenna wire 108 operatively connects the mini-PCI radio 86 to the first antenna 96 so that the mini-PCI radio 86 can send or receive a signal. Connection of the wires 106 and 108 to the antenna 96 on the antenna board 90 may be made in any suitable way, such as by soldering. Similarly, connection of the ground wire 106 to the housing 73 of the computer 70 maybe made in any suitable manner, such as by screwing the ground wire 106 to the housing 73 of the computer 70 using a screw 110.

The second antenna 98 comprises a generally rectangular grounding area 112, a triangular antenna 114, an antenna wire 116, and a ground wire 118. The grounding area 112 provides a ground plane against which the second antenna 98 operates. The triangular antenna 114 comprises the antenna element which sends and receives data. The triangular antenna 114 and grounding area 112 may be formed of any suitable material, such as a metal, and maybe affixed to the antenna board 90 using any suitable method.

Similar to the first antenna 96, the grounding area 112 of the second antenna 98 may take any suitable shape depending on the desired performance of the antenna and how the performance is affected by the access door 72. Further, the grounding wire 118 is configured to ground the second antenna 98, and may be connected to any suitable ground location, such as the housing 73 of the computer 70.

The second antenna 98 may be used to provide a second antenna for the mini-PCI radio 86 located in the second expansion slot 80. As such, the second antenna wire 116 connects the second antenna 98 to the mini-PCI radio 86. Two antennas may be provided for the mini PCI radio 86 so that the radio 86 has a diversity of antennas, which improves coverage of the radio. For instance, the first antenna 96 may comprise a 2.4 giga Hertz (GHz) vertically polarized antenna, and the second antenna 98 may comprise a 2.4 GHz horizontally polarized antenna.

The third antenna 100 comprises a grounding area 120, a bond pad 121, and a third antenna wire 122. Similar to the first and second antennas 96 and 98, the grounding area 120 of the third antenna 100 maybe made of any suitable material, such as a metal, and may take any suitable shape depending on the desired performance of the third antenna 100 and how the performance is affected by the access door 72. The third antenna wire 122 is used to provide a connection between the third antenna 100 and the pico-link radio 88 located in the third expansion slot 82. More specifically, the third antenna 100 may be a 2.4 Ghz vertically polarized antenna.

On a second, smaller antenna board 124, a connection 126 is provided for the Bluetooth™ radio. The second antenna board 124 is affixed to the access door 72 using any suitable method, such as by two screws 128. The second antenna board 124 may comprise a circuit board for use in connection with the operation of the Bluetooth™ radio. The Bluetooth™ radio is not located in an expansion slot 78, 80, and 82, but rather is configured as part of the internal electrical components of the computer 70. At the connection 126, a strip of wires 129 is used to connect the Bluetooth™ radio antenna board 124 to the computer 70.

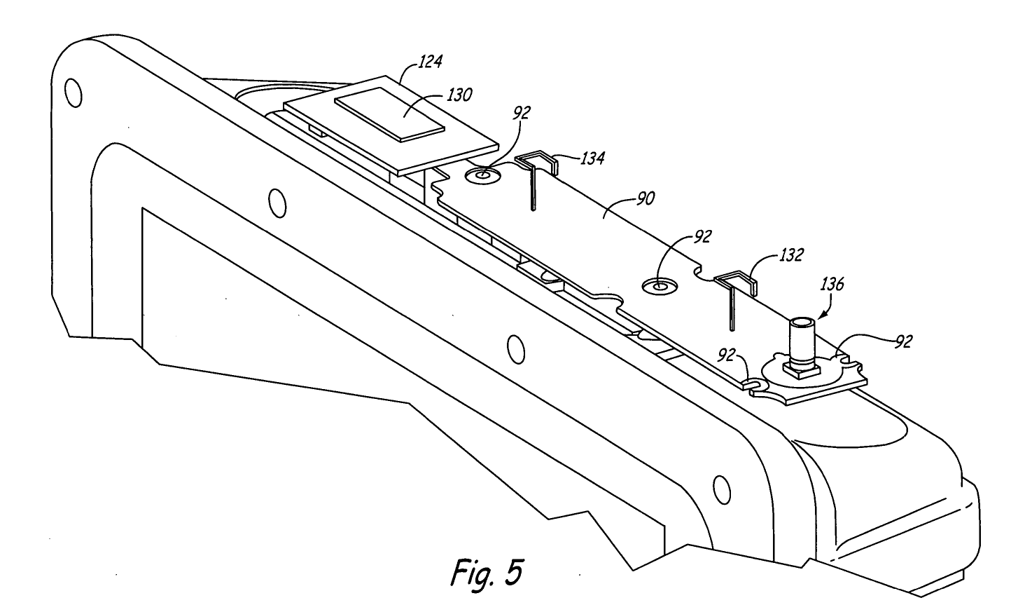

FIG. 5 is a top perspective view of the mobile computer 70 having the access door removed to further illustrate the antenna boards 90 and 124. On the second antenna board 124 is an integrated antenna element 130. This antenna element 130 is configured for use with the Bluetooth™ radio.

On the top of the first antenna board 90 are a first antenna element 132 a second antenna element 134, and external antenna port hardware 136. Also visible in FIG. 5 are several connection locations 92 which correspond to the locations where the antenna board 90 can be connected to the access door 72 (FIG. 4), such as by screws. The first antenna element 132 corresponds to the first antenna 96 of FIG. 4. The second antenna element 134 corresponds to the third antenna 100 of FIG. 4. The antenna elements 132 and 134 form a part of the antennas 96 and 100, and are used to send and receive data. The external antenna port hardware 136 corresponds to the external antenna port 46 of FIG. 2, which allows for plugging an external antenna wire into the computer 70.

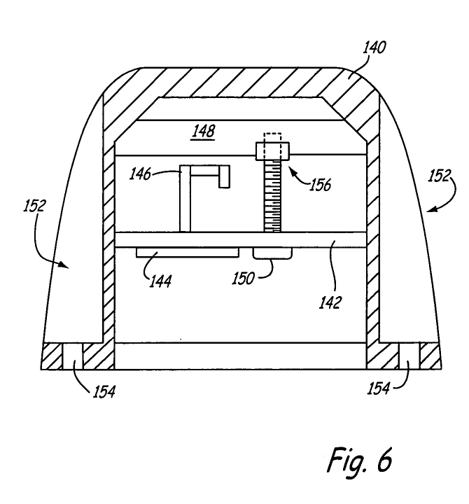

FIG. 6 is a cross sectional view of a radome access door 140. The radome access door 140 comprises an antenna board 142, a grounding area 144, an antenna element 146, across bar 148, a screw 150, and draft angles 150. Two through holes 154 are shown at the bottom of the radome access door 140 in the draft angles 152. The antenna element 146 on the top of the antenna board 142 is integrated with the grounding area 144 on the bottom of the antenna board 142, and together comprise one antenna on the antenna board 142.

FIG. 6 illustrates one method of affixing the antenna board 142 to the radome access door 140. The screw 150 passes through the antenna board 142 and connects to the access door 140 in the cross bar 148 at a screw receiving area 156. The cross bar 148 is formed as part of the radome access door 140, so that once the antenna board 142 is screwed to the cross bar 148, the antenna board 142 is securely fastened inside the door 140. However, any suitable method of connecting the antenna board 142 to the access door 140 may be used.

When mounting the antenna board 142 inside the radome access door 140, it is desired to position the antenna board 142 such that any antennas located on the antenna board 142 have an optimum line of sight to any broadcasting radiation sources. In addition, it is preferable to locate the antennas such that they are separated from the wires and the PC board in the computer housing, to minimize interference from these and other electrical components in the computer and allow the best performance of the antenna array in the radome as possible.

It is desired that when the radome access door 140 is placed on the computer, the antenna board 142 and antenna element 146 are located above the computer housing and computer screen. Often, the computer housing may be made of a metal to ensure the computer is sufficiently rugged. If the antenna board 142 and associated antenna are obscured by the housing, the metal housing will adversely affect the performance of the antennas. It is also desired that the antenna board 142 and antenna element 146 be located in the radome access door 140 so that the antennas are above the computer screen or display. This ensures any shadowing effects caused by the display or other types of interference caused by the computer screen are minimized.

Finally, it is preferable to locate-the antenna board 142 at a location within the radome access door 140 which minimizes the effect of the access door 140 on the antennas. The radome 140 is preferably sized and shaped to provide clearance between the antenna element 146 and the radome plastic. This clearance serves to improve the performance of the antennas.

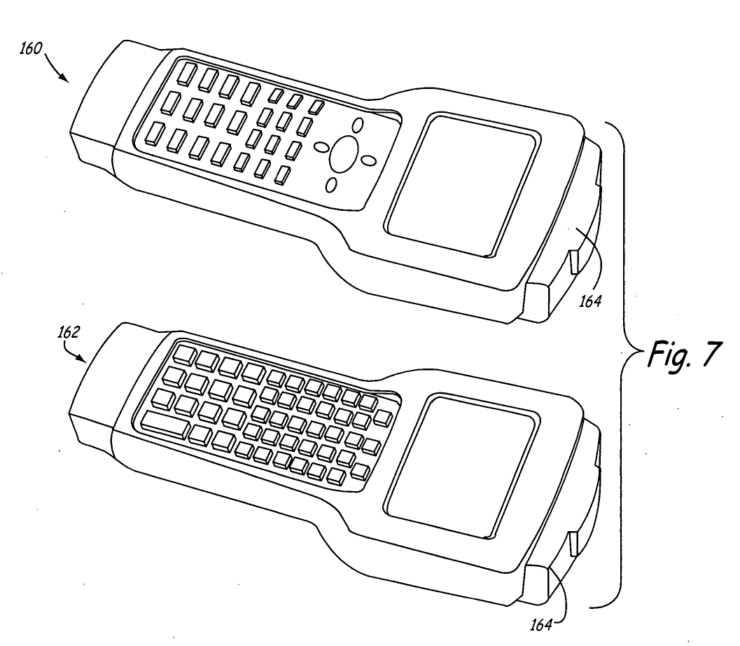

Though discussed in terms of a vehicle-mounted computer, the integrated access door and antenna system may be useful in a wide variety of computer systems. For instance, shown in FIG. 7 are two types of handheld computers 160, 162. The handheld computers can likewise be modified to ensure that an integrated access door and radome 164 is placed on the computer 160, 162. Just as described above with reference to the vehicle-mounted computer, the radomes 164 serve the dual function of access doors allowing a user access to the inner workings of the computers 160, 162, as well as a location for housing antennas necessary for operation of the computers 160, 162.

Though shown as being located across the top of the handheld computers 160, 162, as well as the vehicle-mounted computer 10, the radome/access door may be positioned anywhere suitable to allow for proper performance of the antennas. However, it is preferable to place the integrated access door and antenna near a top surface of the computers to maximize the ability of the antennas to function. Similarly, with handheld computers, placing the integrated access door and antenna near the bottom of the computer is not feasible, because the bottom of the computer is often configured to interconnect with a docking station or charger. Placing an antenna near a docking station or charger is less desirable because it may interfere with the operation of the antennas. This is particularly true when the handheld 160, 162 is placed in the docking station or charger, which may extend up around the base of the computer and thus further reduce the ability of the antenna to send or receive data.

Although the present invention has been described with reference to preferred embodiments, workers skilled in the art will recognize that changes maybe made in form and detail without departing from the spirit and scope of the invention.

1. A mobile computer, the mobile computer comprising:
a computer housing; and
an access door on the housing to access internal electronics of the computer, wherein the access door further comprises an integrated antenna.

2. The mobile computer of claim 1, wherein the computer housing is formed of a metal.

3. The mobile computer of claim 2, wherein the integrated antenna comprises an antenna on an antenna board mounted inside the access door.

4. The mobile computer of claim 3, wherein the access door is sized to provide a clearance between the integrated antenna and a top surface of the access door.

5. The mobile computer of claim 3, wherein the antenna board is mounted to the access door at a position which reduces interference to the integrated antenna caused by a screen on the computer.

6. The mobile computer of claim 3 wherein the antenna board is mounted to the access door at a position which places the integrated antenna above the metal housing.

7. The mobile computer of claim 1, wherein the access door further comprises a location for connecting an external antenna to the computer.

8. The mobile computer of claim 1, and further comprising a gasket to provide a seal between the housing and the access door.

9. The mobile computer of claim 1, wherein the mobile computer comprises a handheld unit and the access door is located near a top surface of the handheld unit.

10. An access door for a mobile computer, the access door comprising:
a radome; and
a plurality of antennas located in the radome.

11. The access door of claim 10, wherein the plurality of antennas comprises a plurality of antennas mounted on an antenna board.

12. The access door of claim 1 1, wherein the radome is sized to provide a clearance between the antenna board and a top surface of the radome.

13. The access door of claim 11, wherein the antenna board is mounted to the radome at a position which optimizes the ability of the antenna to send and receive signals.

14. The access door of claim 10, wherein the radome further comprises a connection for a remote antenna.

15. The access door of claim 10, and further comprising a gasket sized to fit a bottom surface of the access door.

16. The access door of claim 10, wherein the radome is formed of a plastic material.

17. A mobile computer comprising:
a metal housing;
a screen located on the housing for interfacing with the computer;
an access door located on a top side of the metal housing, wherein the access door comprises an integrated antenna located in the access door at a position which allows the antenna to send and receive data with minimal interference from the computer screen or metal housing; and
a radio located inside the metal housing and connected to the integrated antenna located in the access door.

18. The computer of claim 17, wherein the integrated antenna comprises an antenna board comprising a plurality of antennas.

19. The computer of claim 18, wherein the computer comprises a plurality of expansion slots located proximal the top surface of the housing.

20. The computer of claim 19, wherein the radio comprises a pico-link radio located in one of the plurality of expansion slots and wherein the antenna board comprises an antenna connected to the pico-link radio.

21. The computer of claim 20, further comprising
a radio located in one of the plurality of expansion slots; wherein the plurality of antennas comprises a first antenna connected to the radio and a second antenna connected to the radio.

22. The computer of claim 17, wherein the access door further comprises a connection for a remote antenna.

23. The computer of claim 16 and further comprising a gasket forming a seal between the access door and the computer.
